(19) United States
(12) Patent Application Publication
(10) Pub. No.: US 2009/0040258 A1
(43) Pub. Date: Feb. 12, 2009

(54) INKJET IMAGE FORMING APPARATUS AND METHOD OF CONTROLLING THE SAME

(75) Inventor: Oh Hyun BAEK, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/131,251

(22) Filed: Jun. 2, 2008

(30) Foreign Application Priority Data
Aug. 8, 2007 (KR) 2007-79320

(51) Int. Cl. B41J 29/38

(52) U.S. Cl. 347/17

(57) ABSTRACT

A plurality of temperature sensors is provided adjacent to a plurality of nozzles formed in a print head. The temperature sensors are operated according to address information to select the sensor to measure the temperatures of the nozzles. The measured temperatures are compared with a reference temperature such that a missing nozzle is detected. At the time of printing, compensation is provided for the missing nozzle.

### CROSS-REFERENCE TO RELATED APPLICATIONS

This application claims priority under 35 U.S.C. §119(a) from Korean Patent Application No. 2007-79320, filed on Aug. 8, 2007 in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus and a method of controlling the same, which is to compensate for a missing nozzle.

2. Description of the Related Art

An inkjet print head is a device to eject droplets of ink onto a printing medium at a desired position to form an image.

The inkjet print head is generally divided into two types: a thermal driving type and a piezoelectric driving type, according to a mechanism to eject the ink droplets. The thermal driving type inkjet print head generates bubbles in an ink using a heater and ejects the ink droplets by an expansion force of the bubbles.

In the inkjet print head, if some of a plurality of nozzles are blocked, some of heaters or actuators corresponding to the nozzles are erroneously operated, or a circuit to apply power to the heaters or the actuators is damaged, a white line is formed on a printing medium and thus print quality deteriorates.

A nozzle which does not eject the ink due to such a damaged condition is called a missing nozzle. A technology of detecting the missing nozzle has been developed.

As an example of a method of detecting a missing nozzle, a method of scanning the result printed by a printing unit and detecting a missing nozzle is disclosed in Korean Patent Registration No. 10-636236.

In this method, the ink is ejected onto a printing medium through nozzles to print a test pattern and the test pattern is scanned by a scan sensor, thereby detecting the missing nozzle.

However, in the conventional missing nozzle detecting method, since the test pattern should be printed and scanned in order to detect the missing nozzle, the process is troublesome and complicated and the missing nozzle cannot be rapidly detected.

In addition, since positional information of the missing nozzle is detected using the scan sensor, accurately detecting the position of the missing nozzle is difficult.

Japanese Unexamined Patent Application Publication No. 05-309832 relates to an inkjet recording head to measure a temperature of a print head and determine an ink ejection state of the print head according to the measured temperature.

The inkjet recording head in the above publication measures an average temperature of the head and detects whether the ink is normally ejected. However, since the temperatures of the nozzles are not individually measured, accurately detecting a missing nozzle which generates a white line is difficult.

Accordingly, in order to accurately detect the missing nozzle using the temperature measurement method, a number of temperature measurement points is large. Accordingly, the temperature measurement points may be respectively set with respect to the nozzles of the print head.

As described above, the missing nozzle is generated due to a variety of causes. If some of the plurality of nozzles is blocked to generate the missing nozzle, a foreign material, which blocked a nozzle hole or an inlet of a channel connected to the nozzle, may be moved to another nozzle at a time of a print operation. Accordingly, the position of the missing nozzle may be changed. In order to accurately detect the missing nozzle, a number of times of detection should not be limited to one time or several times. That is, the missing nozzle needs to be frequently detected.

In an array head structure to rapidly print an image using a print head including a head chip having a same width and length as a printing medium, a large number of nozzles are formed in the print head.

In addition to the array head structure, if a number of missing nozzles to be detected is large and the detection operation needs to be frequently performed during the printing operation, the capability of rapidly and accurately performing the detection operation should be ensured.

As a number of nozzles is increased, a number of circuit configurations to detect the missing nozzle is increased and an area of the head chip is increased. Accordingly, a method of detecting the missing nozzle by a simple configuration is required.

In the inkjet print head, when an operation to compensate for the missing nozzle as well as the operation to detect the missing nozzle is performed, the print quality can be substantially prevented from deteriorating due to the missing nozzle. Accordingly, the operation to detect the missing nozzle and the operation to compensate for the missing nozzle should be adequately performed during the printing operation.

### SUMMARY OF THE INVENTION

The present general inventive concept provides rapidly and accurately performing a series of operations to measure temperatures of nozzles of a print head and detect and compensate for a missing nozzle during which print data is printed.

The present general inventive concept also provides shortening a time necessary to sequentially turn on power transistors respectively connected to the plurality of nozzles and checking all the nozzles.

The present general inventive concept also provides detecting a missing nozzle by a simple configuration, because portions to process temperature measurement values are shared except that power transistors are individually included.

Additional aspects and/or utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an inkjet image forming apparatus including a temperature sensing portion which is provided in a print head and includes a plurality of temperature sensors to individually sense temperatures of a plurality of nozzles, a selector to selectively drive the plurality of temperature sensors of the temperature sensing portion, and a controller to control the selector so as to sequentially drive the plurality of temperature sensors, to detect a missing nozzle according to the temperatures sensed through the plurality of temperature sensors, and to compensate for the detected missing nozzle.

The selector may include a switch including a plurality of transistors respectively connected to the plurality of temperature sensors, a sensor driver to drive any one of the plurality of transistors, and a sensor decoder to supply address information according to an operation sequence of the transistors to the sensor driver so as to sequentially drive the plurality of transistors.

The inkjet image forming apparatus may further include a signal processing portion to process a temperature measurement value supplied from any one of the plurality of temperature sensors of the temperature sensing portion.

The signal processing portion may include an amplifier to amplify the temperature measurement value of the temperature sensing portion, a noise filter to eliminate noise included in an output signal of the amplifier, and a signal converter to convert the temperature measurement value, from which the noise is eliminated by the noise filter, into a digital signal.

The inkjet image forming apparatus may further include a memory to store temperature measurement data of the plurality of nozzles, which is measured through the plurality of temperature sensors of the temperature sensing portion.

Each of the temperature sensors may be a thin-film thermocouple positioned adjacent to each of the plurality of nozzles.

The foregoing and/or other aspects and utilities of the general inventive concept may also be achieved by providing a method of controlling an inkjet image forming apparatus, the method including starting a print operation, selectively driving a plurality of temperature sensors corresponding to a plurality of nozzles and detecting a missing nozzle during which a first page of a document is printed, and compensating for the detected missing nozzle and printing a next page of a document.

The detecting of the missing nozzle may include measuring the temperatures through the temperature sensors in a sequence determined according to address information corresponding to the plurality of nozzles, comparing the measured temperatures with a predetermined reference temperature, and determining a nozzle, of which measured temperature exceeds the reference temperature in the compared result, as the missing nozzle.

The foregoing and/or other aspects and utilities of the general inventive concept may also be achieved by providing an inkjet image forming apparatus including a plurality of nozzles formed in a print head, a plurality of temperature sensors which are provided adjacent to the plurality of plurality of nozzles and individually senses temperatures of the plurality of nozzles, a plurality of transistors respectively connected to the temperature sensors, a sensor decoder to supply address information according to an operation sequence of the transistors so as to sequentially drive the plurality of transistors, a sensor driver to drive any one of the plurality of transistors according to the address information of the sensor decoder, and a controller to control the sensor decoder at the time of a print operation, to detect a missing nozzle according to the temperatures sensed through the plurality of temperature sensors, to compensate for the detected missing nozzle, and to perform the print operation.

The foregoing and/or other aspects and utilities of the general inventive concept may also be achieved by providing an inkjet print head usable with an image forming apparatus, the print head including a plurality of nozzles, a plurality of temperature sensors disposed proximate to the plurality of nozzles to individually sense temperatures of a plurality of nozzles, wherein each of the plurality of temperature sensors are formed by a plurality of metal layers.

Each of the plurality of temperature sensors may further include an intersection portion of the each of the plurality of metal layers disposed adjacent to each nozzle to be measured.

The inkjet print head may further include a controller to detect a missing nozzle according to the temperatures sensed through the plurality of temperature sensors, and to compensate for the detected missing nozzle.

The foregoing and/or other aspects and utilities of the general inventive concept may also be achieved by providing a computer-readable recording medium having embodied thereon a computer program to execute a method, wherein the method includes starting a print operation, selectively driving a plurality of temperature sensors corresponding to a plurality of nozzles and detecting a missing nozzle during which a first page of a document is printed, and compensating for the detected missing nozzle and printing a next page of a document.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic plan view illustrating a configuration of an inkjet print head according to an embodiment of the present general inventive concept;

FIG. 2 is a cross-sectional view taken along line I-I of FIG. 1;

FIG. 3 is a schematic partial exploded perspective view illustrating a configuration of the inkjet print head according to the embodiment of the present general inventive concept;

FIG. 4 is a control block diagram illustrating an inkjet image forming apparatus according to the embodiment illustrated in FIG. 1;

FIG. 5 is a graph illustrating a method of detecting a missing nozzle according to the embodiment of the present general inventive concept; and

FIG. 6 is a flowchart illustrating a method of controlling the inkjet image forming apparatus according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below to explain the present general inventive concept by referring to the figures.

The inkjet image forming apparatus according to a present embodiment of the present general inventive concept detects a missing nozzle from nozzles, which are formed in an inkjet print head so as to eject an ink. In order to detect the missing nozzle, temperature measurement information obtained through a temperature sensing portion provided in the print head is used.

In the present embodiment, the temperature sensing portion uses a thin-film thermocouple. If the thin-film thermocouple is used, many temperature measurement points are set in the print head. In addition, the thin-film thermocouple may be manufactured having a very small size such that temperatures of the nozzles can be individually measured. With respect to a structure of the temperature sensing portion, a patent application filed by the present applicant and an example thereof is disclosed in Korean Patent Application No. 10-2007-65439 which is herein incorporated by reference in its entirety. Hereinafter, an example of employing the structure of the temperature sensing portion disclosed in the above publication will be described.

The inkjet print head according to the present embodiment is a thermal driving type inkjet print head to generate bubbles in ink using heaters and to eject ink droplets by expansion force of the bubbles.

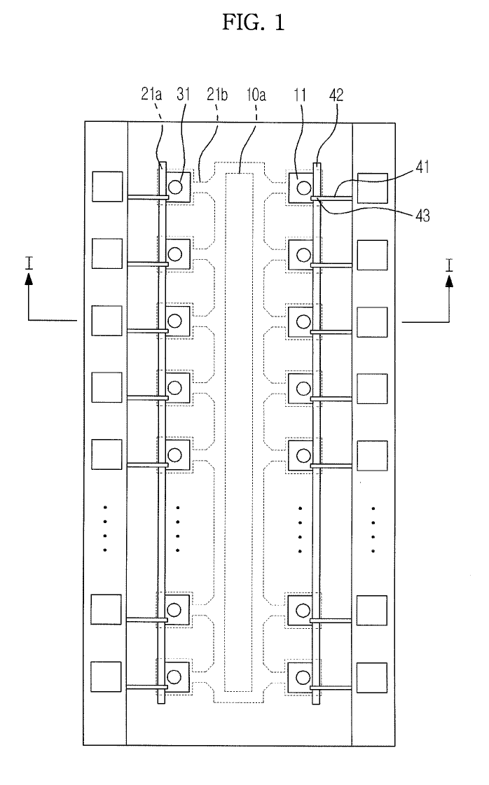

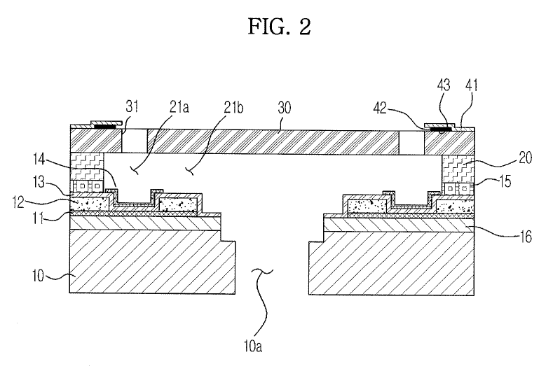

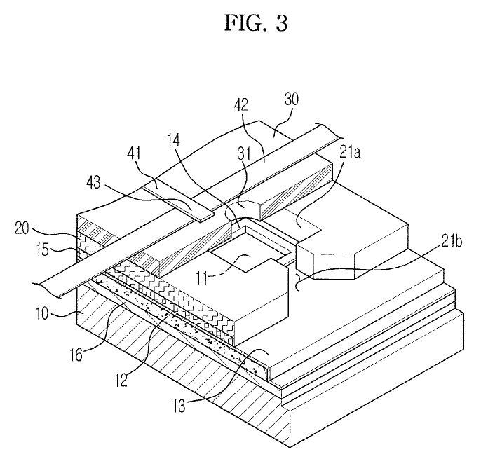

FIG. 1 is a schematic plan view illustrating a configuration of an inkjet print head according to an embodiment of the present general inventive concept, FIG. 2 is a cross-sectional view taken along line I-I of FIG. 1, and FIG. 3 is a schematic partial exploded perspective view illustrating the configuration of the inkjet print head according to the embodiment illustrated in FIG. 1.

Referring to FIGS. 1-3, the inkjet print head according to the present embodiment includes a substrate 10, on which heaters 11 are mounted, as an ejection pressure generator for ink ejection, as illustrated in FIGS. 1 to 3. Electrodes 12 are formed on the heaters 11 and at least one of a passivation layer 13 and anti-cavitation layers 14 may be further formed on the electrodes 12. A channel forming layer 20 to define a chamber 21a is laminated on the substrate 10, and a nozzle layer 30, in which nozzles 31 to eject the ink are formed, is laminated on the channel forming layer 20. An adhesive layer 15 is interposed between the channel forming layer 20 and the substrate 10 such that the channel forming layer 20 is stably adhered to the substrate 10. A temperature sensing portion 43 to sense temperatures of the nozzles 31 is formed on the nozzle layer 30.

The substrate 10 is a silicon wafer, and an ink feeding port 10a through which the ink is fed from an ink container (not illustrated) is formed in the substrate 10. Each heater 11 is a general thin-film heater formed on the substrate 10, to convert an electrical signal received from the electrode 12 into thermal energy and heats the ink in the chamber 21a. The heater 11 may include a heat generating resistant material such as tantalum nitride (TaN) or tantalum aluminum (TaAl) may be used. Each electrode 12 is formed by depositing a metal material having good conductivity, such as aluminum, and patterning the deposited metal layer formed on the heaters 11 in a predetermined wiring form by a photolithography process and an etching process. Each electrode 12 receives a signal from a general CMOS logic and a power transistor and sends the signal to each heater 11.

A heat storage layer 16, which is an insulating layer made of a silicon oxide film, may be provided between the heaters 11 and the substrate 10. The heat storage layer 16 prevents the heat generated by the heaters 11 from being dissipated to the substrate 10.

The passivation layer 13 prevents the heaters 11 and the electrodes 12 from being oxidized or being directly brought into contact with the ink to protect the heaters 11 and the electrodes 12. The passivation layer 13 may be formed of a silicon nitride film (SiN) having a good insulation property and a good heat transfer property. The anti-cavitation layers 14 may be formed on the passivation layer 13 in correspondence with heat generation regions of the heaters 11 corresponding to the nozzles 31.

The anti-passivation layers 14 protect the heaters 11 from a cavitation force generated when bubbles are contacted and disappeared in the chamber 21a and prevent the heaters 11 from being corroded from the ink. Each anti-passivation layer 14 is formed by depositing tantalum (Ta) on the passivation layer 13 with a predetermined thickness.

The channel forming layer 20 defines ink channels 21, 21a and 21b to connect the ink feeding port 10a to the nozzles 31. The ink channel 21 includes the chamber 21a in which the ink is filled and a restrictor 21b to connect the ink feeding port 10a to the chamber 21a.

First and second metal layers 41 and 42, which form the temperature sensing portion 43 to sense the temperatures of the nozzles 31, are formed on the nozzle layer 30.

The temperature sensing portion 43 is formed of the thin-film thermocouple because the thin-film thermocouple is suitable to measure the temperature of a specific point.

In order to facilitate the understanding of the description, the thermocouple is a temperature sensor using the Seebeck effect, in which two dissimilar metals form a circuit loop, one metal makes up one portion of the loop, and the other metal makes up an other portion. When a high temperature is applied to one of two contacts between the two metals and a lower temperature is applied to an other of the two contacts, a voltage difference will be generated due to the temperature differences of the two contacts and the types of the metals configuring the circuit loop.

Accordingly, the thermocouple may obtain a temperature measurement signal by directly connecting one of the contacts between the two metals to a region, of which the temperature is desired to be measured, and measuring voltage differences of other ends of the two metals which are not in contact with each other in a state of being opened. The thrermocouple can easily obtain the temperature of the measurement region using the temperature measurement signal and may be variously classified according to the types of the two metals configuring the thermocouples.

In the present embodiment, a k-type thermocouple using chromel and alumel is used.

Accordingly, in the present embodiment, one end of the first metal layer 41 and the second metal layer 42 are formed on the nozzle layer 30 to be adjacent to each of the nozzles 31 such that the temperatures of the nozzles 31 can be easily measured.

The first metal layer 41 may be formed by depositing chromel by sputtering or a chemical vapor deposition method and patterning chromel, and the second metal layer 42 may be formed by depositing alumel by a same method and patterning the alumel.

The temperature sensing portion 43 is provided on the nozzle layer 30 at a plurality of points in correspondence with the plurality of nozzles.

The temperature sensing portion 43 measures the temperatures of the nozzles 31. The temperatures measured by the temperature sensing portion 43, for example, are subjected to the below-described signal processing and are converted into digital signals, which are then sent to a controller.

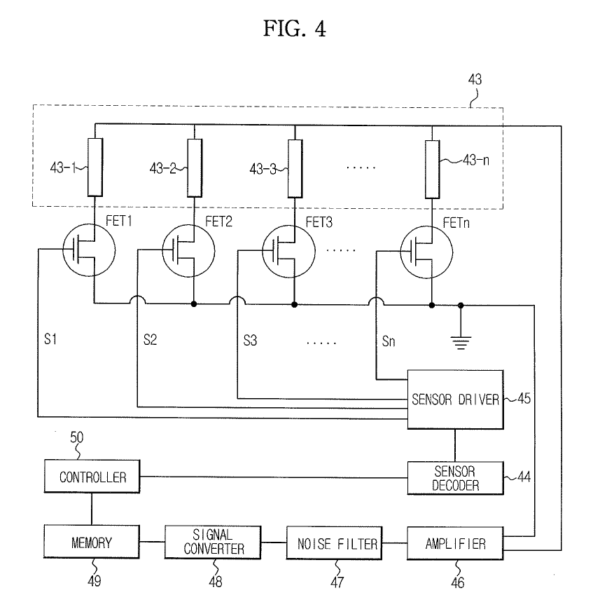

As illustrated in FIG. 4, the temperature sensing portion 43 includes a plurality of temperature sensors 43-1, 43-2, . . . , and 43-n in correspondence with the plurality of nozzles formed in the print head.

The plurality of temperature sensors 43-1, 43-2, . . . , and 43-n are formed of the thin-film thermocouples to sense the temperatures of the nozzles. Since the first and second metal layers 41 and 42 (FIG. 1) forming the temperature sensors are shared, a design area of the print head having the nozzles can be reduced and the total area of the print head can be minimized.

Each of the plurality of temperature sensors 43-1, 43-2, . . . , and 43-n is an intersection portion of the first and second metal layers, which is positioned adjacent to each nozzle to be measured.

The plurality of temperature sensors 43-1, 43-2, . . . , and 43-n are respectively connected to a plurality of power transistors FET1, FET2, . . . , and FETn. The operations of the plurality of power transistors FET1, FET2, . . . , and FETn may be controlled such that the temperature is selectively measured by any one of the temperature sensors. The temperatures of the nozzles are sequentially measured in a predetermined sequence so as to perform the missing nozzle detection operation with respect to all the nozzles.

Although several temperature sensors can be theoretically operated in the circuit illustrated in FIG. 4, measuring the temperatures using the measurement signals according to specific positions is difficult, since the temperature sensors share the first and second metal layers.

In the present embodiment, in order to sequentially perform the missing nozzle detection operation with respect to the plurality of nozzles and selectively operate the power transistors corresponding to the nozzles on a basis of addresses corresponding to the plurality of nozzles, a sensor decoder 44 and a sensor driver 45 are further included.

The sensor decoder 44 has information on the addresses of the nozzles to be measured and applies the addresses to the sensor driver 45 in order to drive the temperature sensors according to a predetermined sequence according to a control signal of the controller 50.

The sensor driver 45 outputs a turn-on signal to operate a transistor corresponding to the received address. Here, the turn-on signal selectively operates any one power transistor. The operation to individually measure the temperatures of the nozzles to detect the missing nozzle is performed, but an operation to measure the temperature of one nozzle is performed for a short time (several microseconds). Accordingly, although the temperatures of all the nozzles are individually measured, the time consumed to detect the missing nozzle with respect to all the nozzles is not long.

When at least one of the plurality of power transistors FET1, FET2, . . . , and FETn is turned on, the temperature sensor corresponding thereto forms a circuit loop such that the temperature is measured.

Since the temperature measurement value is small, the temperature measurement value should be subjected to a signal processing operation so as to be recognized as the temperature measurement information.

The signal processing operation is performed by an amplifier 46, a noise filter 47 and a signal converter 48. Detection information of the nozzles is stored in a memory 49.

The amplifier 46 is connected to an output side of the temperature sensing portion 43. The amplifier 46 amplifies the small temperature measurement values obtained by measuring the temperature to an appropriate level and outputs the amplified signal to the noise filter 47. The noise filter 47 is a low-pass filter (LPF), which eliminates noise which occurs in the process of measuring the temperature or amplifying the temperature measurement value.

The signal converter 48 converts the temperature measurement signal from which noise is eliminated by the filter to digital data and stores the converted data in the memory 49.

The memory 49 is a buffer to temporarily store temperature information of the nozzles.

The controller 50 compares the temperatures of the nozzle read from the memory 49 with a predetermined reference temperature and detects whether the nozzle is the missing nozzle.

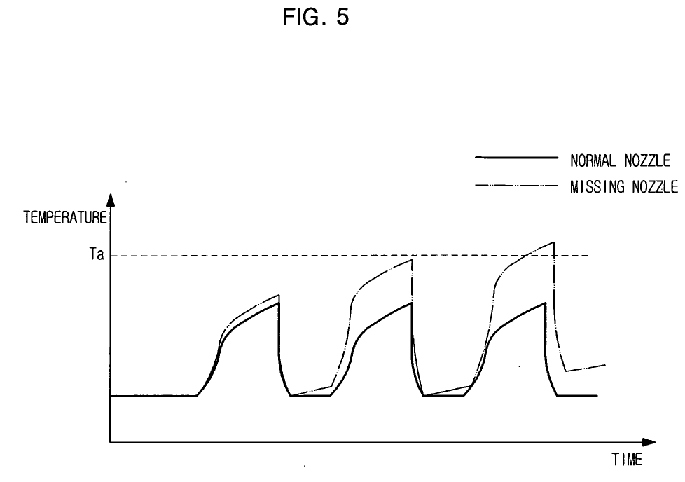

For example, as illustrated in FIG. 5, a normal nozzle has a good ink ejection property because heat generated at a time of heating the ink escapes through the nozzle hole, but the missing nozzle has a bad ink ejection property because heat generated at the time of heating the ink does not escape through the nozzle hole. In this state, when the heater is periodically operated to heat the ink, the heat generated at the time of heating the ink is accumulated and, as a result, the temperature of the nozzle exceeds a predetermined maximum temperature Ta. This nozzle having the temperature larger than the predetermined maximum temperature Ta is recognized as the missing nozzle.

When the missing nozzle is detected, the controller 50 prevents print quality from deteriorating using various missing nozzle compensation methods. An example of the missing nozzle compensation method is disclosed in Korean Unexamined Patent Application Publication No. 10-2006-67056 filed by the present applicant and herein incorporated by reference in its entirety.

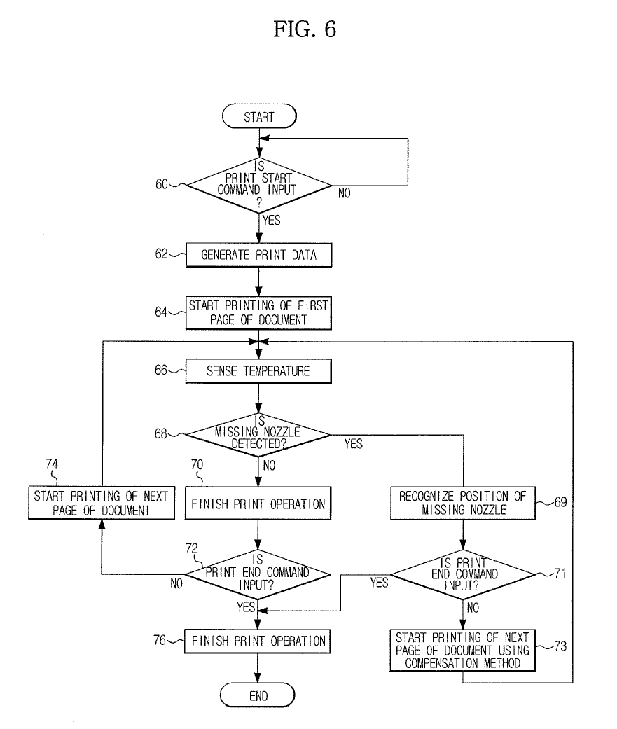

Hereinafter, a method of controlling an inkjet image forming apparatus according to an embodiment of the present general inventive concept will be described with reference to FIG. 6.

Referring to FIGS. 4 and 6, the controller 50 determines whether a print start command is input (operation 60). If the print start command is input, the controller 50 converts data received from a computer or a scanning device (not illustrated) into a form suitable for print and generates print data (operation 62).

Then, the heater of the print head is driven and the ink is ejected such that a first page of a document is started to be printed (operation 64).

When the print operation is started, the controller 50 applies a control signal for temperature measurement to the sensor decoder 44. The sensor decoder 44 sequentially supplies the information on the addresses of the plurality of nozzles to the sensor driver 45 in the predetermined sequence such that the temperatures of the nozzles are sequentially measured. The sensor driver 45 supplies any one of a plurality of switching signals S1, S2, . . . , and Sn to a corresponding power transistor in correspondence with the address of the nozzle received from the sensor decoder 44. Accordingly, the corresponding power transistor is turned on. The temperature of the nozzle is measured by the corresponding temperature sensor (operation 66).

The controller 50 determines whether the temperature of the nozzle read from the memory 49 exceeds the reference temperature Ta, that is, whether the missing nozzle is detected (operation 68). If a determination is made that the missing nozzle is not detected, then a page of a document is continuously printed and the print operation is finished (operation 70). Then, a determination is made whether a print end command is input (operation 72). If a determination is made that the print end command is not input, then a next page of a document is started to be printed (operation 74) and the operation to detect the missing nozzle is performed in Operation 66. If a determination is made that the print end command is input, the print operation is finished (operation 76).

If a determination is made that the missing nozzle is detected in Operation 68, then the controller 50 reads the information stored in the memory 49 and recognizes the position of the missing nozzle (operation 69). Then, a determination is made whether the print end command is input (operation 71). If a determination is made that the print end command is not input, then a next page of a document is printed while the missing nozzle is compensated by the existing missing nozzle compensation method (operation 73). Then, the method progresses to Operation 66 and the operation to detect the missing nozzle is performed.

If a determination is made that the print end command is input in Operation 71, the print operation is finished (operation 76).

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. An inkjet image forming apparatus, comprising:
a temperature sensing portion which is provided in a print head and includes a plurality of temperature sensors to individually sense temperatures of a plurality of nozzles;
a selector to selectively drive the plurality of temperature sensors of the temperature sensing portion; and
a controller to control the selector so as to sequentially drive the plurality of temperature sensors, to detect a missing nozzle according to the temperatures sensed through the plurality of temperature sensors, and to compensate for the detected missing nozzle.

2. The inkjet image forming apparatus according to claim 1, wherein the selector comprises:
a switch including a plurality of transistors respectively connected to the plurality of temperature sensors;
a sensor driver to drive any one of the plurality of transistors; and
a sensor decoder to supply address information according to an operation sequence of the transistors to the sensor driver so as to sequentially drive the plurality of transistors.

3. The inkjet image forming apparatus according to claim 1, further comprising:
a signal processing portion to process a temperature measurement value supplied from any one of the plurality of temperature sensors of the temperature sensing portion.

4. The inkjet image forming apparatus according to claim 3, wherein the signal processing portion comprises:
an amplifier to amplify the temperature measurement value of the temperature sensing portion;
a noise filter to eliminate noise included in an output signal of the amplifier; and
a signal converter to convert the temperature measurement value, from which the noise is eliminated by the noise filter, into a digital signal.

5. The inkjet image forming apparatus according to claim 1, further comprising:
a memory to store temperature measurement data of the plurality of nozzles, which is measured through the plurality of temperature sensors of the temperature sensing portion.

6. The inkjet image forming apparatus according to claim 1, wherein each of the temperature sensors is a thin-film thermocouple positioned adjacent to each of the plurality of nozzles.

7. A method of controlling an inkjet image forming apparatus, the method comprising:
starting a print operation;
selectively driving a plurality of temperature sensors corresponding to a plurality of nozzles and detecting a missing nozzle during which a first page of a document is printed; and
compensating for the detected missing nozzle and printing a next page of a document.

8. The method according to claim 7, wherein the detecting of the missing nozzle comprises:
measuring the temperatures through the temperature sensors in a sequence determined according to address information corresponding to the plurality of nozzles;
comparing the measured temperatures with a predetermined reference temperature; and
determining a nozzle, of which measured temperature exceeds the reference temperature in the compared result, as the missing nozzle.

9. An inkjet image forming apparatus, comprising:
a plurality of nozzles formed in a print head;
a plurality of temperature sensors which are provided adjacent to the plurality of plurality of nozzles and individually senses temperatures of the plurality of nozzles;
a plurality of transistors respectively connected to the temperature sensors;
a sensor decoder to supply address information according to an operation sequence of the transistors so as to sequentially drive the plurality of transistors;
a sensor driver to drive any one of the plurality of transistors according to the address information of the sensor decoder; and
a controller to control the sensor decoder at the time of a print operation, to detect a missing nozzle according to the temperatures sensed through the plurality of temperature sensors, to compensate for the detected missing nozzle, and to perform the print operation.

10. An inkjet print head usable with an image forming apparatus, the print head comprising:
a plurality of nozzles;
a plurality of temperature sensors disposed proximate to the plurality of nozzles to individually sense temperatures of a plurality of nozzles,
wherein each of the plurality of temperature sensors are formed by a plurality of metal layers.

11. The inkjet print head according to claim 10, wherein each of the plurality of temperature sensors further comprises:
an intersection portion of the each of the plurality of metal layers disposed adjacent to each nozzle to be measured.

12. The inkjet print head according to claim 10, further comprises:
a controller to detect a missing nozzle according to the temperatures sensed through the plurality of temperature sensors, and to compensate for the detected missing nozzle.
